(19) United States
(12) Patent Application Publication
(10) Pub. No.: US 2007/0189719 A1
(43) Pub. Date: Aug. 16, 2007

(54) Video reproducing apparatus, data structure of bookmark data, storage medium storing bookmark data, and method of generating bookmark data cross-reference to related applications

(75) Inventors: Ryohei Furumachi, Tokyo (JP); Hideyuki Tsutsumitake, Tokyo (JP); Takero Kobayashi, Tokyo (JP); Kazutoshi Horiguchi, Tokyo (JP); Shunichi Kawabata, Tokyo (JP); Hiroaki Uchida, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/653,307

(22) Filed: Jan. 16, 2007

(30) Foreign Application Priority Data
Jan. 31, 2006 (JP) JP2006-023165

(51) Int. Cl. H04N 7/00

(52) U.S. Cl. 386/95

(57) ABSTRACT

According to one embodiment, a video reproducing apparatus generates bookmark data and stores it in a hard disk drive or the like. The bookmark data has first restoration information for restoring the reproduction status when video contents were reproduced using moving image/sound data contained in video content data for reproducing the video contents, and second restoration information for restoring the reproduction status when content-related data reproduced in relation to the video contents was reproduced.

### CROSS-REFERENCE TO RELATED APPLICATIONS

This application is based upon and claims the benefit of priority from Japanese Patent Application No. 2006-23165, filed Jan. 31, 2006, the entire contents of which are incorporated herein by reference.

### BACKGROUND

1. Field

One embodiment of the invention relates to a video reproducing apparatus with a function of generating bookmark data used in reproducing video contents, a data structure of the bookmark data, a storage medium storing the bookmark data, and a method of generating the bookmark data.

2. Description of the Related Art

Conventionally, there has been an data recording and reproducing apparatus capable of recording and reproducing video and sound as digital data. As the data recording and reproducing apparatus of this kind, a so-called DVD recorder is widely used which uses a DVD (digital versatile disk) as a recording medium, so that the apparatus can record digital data on the recording medium and read digital data recorded thereon to reproduce the video and sound.

Incidentally, an apparatus using an optical disk like a DVD recorder and an data recording and reproducing apparatus which records and reproduces video and sound after digitalizing them, such as a digital video camera may conventionally incorporate a function for registering an arbitrary position in the recorded video and the like (a so-called bookmark). In this kind of data recording and reproducing apparatus, the bookmark data registered using the bookmark can be used to display the video at the position corresponding to the bookmark data and reproduce the video and sound from the position or time corresponding to the bookmark data.

As for an data recording and reproducing apparatus which incorporates a conventional bookmark, for example, Japanese Patent Application Publication (KOKAI) No. 2004-127369 (Patent Document 1) discloses a data management method, a data display method, a recording and reproducing apparatus, and a recording medium in which first management information relating to a recording position of first part data recorded on the recording medium and second management information relating to second part data contained in the first part data are recorded on the recording medium so as to manage the recorded data in more detail.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing an internal configuration of a video reproducing apparatus according to an embodiment of the invention along with a recording medium and a network storage;

FIG. 2 is an exemplary block diagram showing the configuration of functions of a player program, a moving image/audio reproduction program, and an interactive data reproduction program which are executed in the video reproducing apparatus along with data to be inputted thereinto and outputted therefrom in the embodiment;

FIG. 3 is an exemplary diagram showing one example of a reproduction schedule when video and sound are reproduced using the moving image/sound data and the interactive data in the embodiment;

FIG. 4 is an exemplary diagram showing the reproduction time of the moving image/sound data and the interactive data;

FIG. 5 is an exemplary layout diagram showing the data structure of bookmark data in the embodiment;

FIG. 6 is an exemplary diagram showing one example of a bookmark selection menu in a thumbnail format in the embodiment;

FIG. 7 is an exemplary diagram showing one example of a bookmark information screen in the embodiment;

FIG. 8 is an exemplary diagram showing one example of the bookmark selection menu in a progress bar type in the embodiment;

FIG. 9 is an exemplary flow chart showing an operation procedure of bookmark generation processing in the embodiment;

FIG. 10 is an exemplary flow chart showing the operation procedure subsequent to FIG. 9 in the embodiment;

FIG. 11 is an exemplary flow chart showing an operation procedure of reproduction start preparation processing in the embodiment; and

FIG. 12 is an exemplary flow chart showing the operation procedure subsequent to FIG. 11 in the embodiment.

### DETAILED DESCRIPTION

Various embodiments according to the invention will be described hereinafter with reference to the accompanying drawings. In general, according to one embodiment of the invention, a video reproducing apparatus is included a bookmark generation unit for generating bookmark data. The bookmark data has first restoration information for restoring the reproduction status when video contents were reproduced using moving image/sound data contained in video content data for reproducing the video contents, and second restoration information for restoring the reproduction status when content-related data reproduced in relation to the video contents was reproduced.

### (Configuration of Video Reproducing Apparatus)

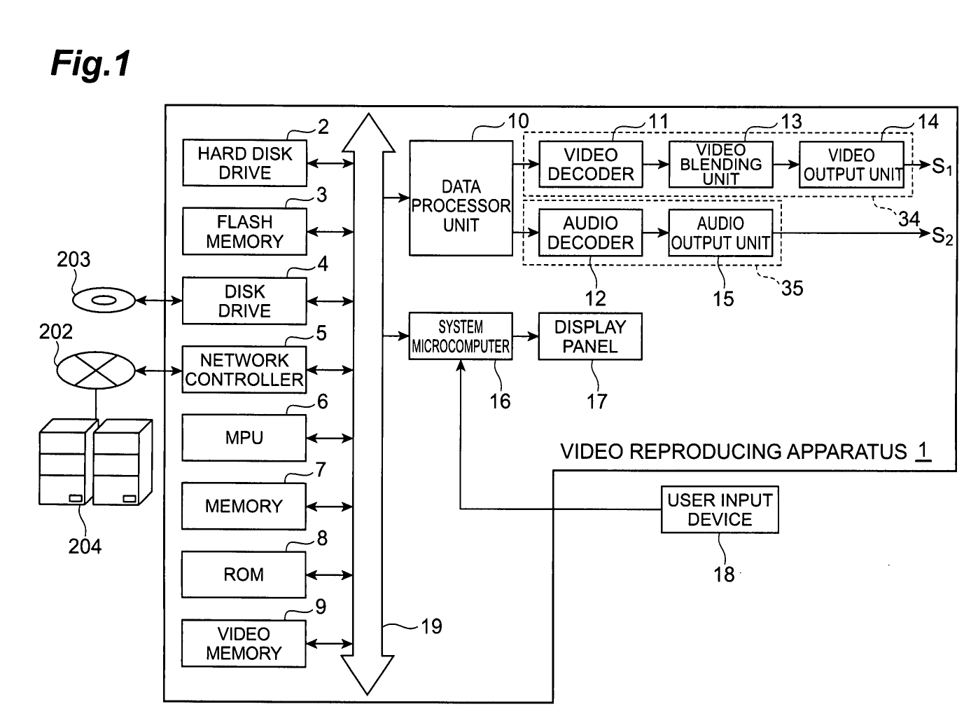

A video reproducing apparatus 1 according to an embodiment of the present invention will be described with reference to FIG. 1. FIG. 1 is an exemplary block diagram showing the internal configuration of the video reproducing apparatus 1 along with a recording medium 203 and a network storage 204. As shown in FIG. 1, the video reproducing apparatus 1 inserts the recording medium 203 such as an optical disk or the like and has the following configuration. Namely, the video reproducing apparatus 1 has a configuration such that it can read later-described video content data 33 in a digital form recorded on the recording medium 203 to reproduce video contents (for example, movie, drama and so on) and interactive data, and can connect to the network storage 204 via the Internet 202 to acquire the video content data 33 also from the network storage 204 to reproduce video contents and interactive data.

The video reproducing apparatus 1 has a hard disk drive 2, a flash memory 3, a disk drive 4, and a network controller 5 all of which are connected to a bus 19. The hard disk drive 2 records digital data such as the video content data 33 and the like on a magnetic disk rotated at a high speed to read/write the digital data. The flash memory 3 stores digital data such as the video content data 33 and the like from/to which the digital data is read/written. Further, the hard disk drive 2 and the flash memory 3 store later-described bookmark data 40 and have a function as a storage medium in the present invention. The disk drive 4 reads the digital data such as the video content data 33 and the like from the storage medium 203 and outputs a reproduced signal. The network controller 5 controls reading/writing of the digital data such as the video content data 33 and the like performed to/from the network storage 204 via the Internet 202.

The video reproducing apparatus 1 further has an MPU (Micro Processing Unit) 6, a memory 7, a ROM 8, and a video memory 9 all of which are connected to the bus 19. The MPU 6 is booted according to a boot program read out from the ROM 8 to the memory 7′. The MPU 6 also reads out a player program 30 from the ROM 8 to the memory 7 and, according to the player program 30, controls system initialization, control of other programs (for example, a later-described moving image/sound reproduction program 31 and so on), system termination, and so on to thereby operate a later-described system microcomputer 16.

The MPU 6 further instructs a later-described data processor unit 10 to reproduce video and sound using the video content data read out from any of the recording medium 203, the network storage 204, the hard disk drive 2, and the flash memory 3. The memory 7 stores the data and programs used when the MPU 6 operates. The ROM 8 stores programs executed by the MPU 6 such as the boot program and the player program 30, and permanent data. Into the video memory 9, decoded video data is written in sequence.

The video reproducing apparatus 1 further has the data processor unit 10, a video decoder 11, an audio decoder 12, a video blending unit 13, a video output unit 14, and an audio output unit 15 which constitute a video reproducing device, as well as the system microcomputer 16 and a display panel 17. The data processor unit 10 executes the moving image/sound reproduction program 31 in response to the instruction of the MPU 6 inputted via the bus 19. The data processor unit 10 then separates the video content data read out from any of the recording medium 203, the network storage 204, the hard disk drive 2, and the flash memory 3 and supplies the moving image data to the video decoder 11 and the audio data to the audio decoder 12.

The video decoder 11 decodes the moving image data supplied from the data processor unit 10 into video data and supplies the video data to the video blending unit 13. The video blending unit 13 performs blend processing for the video data supplied from the video decoder 11 to generate blended video data and supplies the generated blended video data to the video output unit 14. The video output unit 14 outputs a video output signal S1 corresponding to the supplied blended video data.

The audio decoder 12 decodes the audio data supplied from the data processor unit 10 into decoded audio data and supplies the decoded audio data to the audio output unit 15. The audio output unit 15 outputs an audio output signal S2 corresponding to the supplied decoded audio data.

The system microcomputer 16 causes the display panel 17 to display various kinds of information on reproduction of the video contents and interactive data (reproduction information), and inputs an operation input signal inputted from a user input device 18 (a device which allows for operation input, such as a remote controller or an operation button or the like provided on the video reproducing apparatus 1), into the MPU 6 via the bus 19. The display panel 17 has a liquid crystal display panel and displays the reproduction information on the liquid crystal display panel according to the instruction of the system microcomputer 16.

### (Configuration of Program)

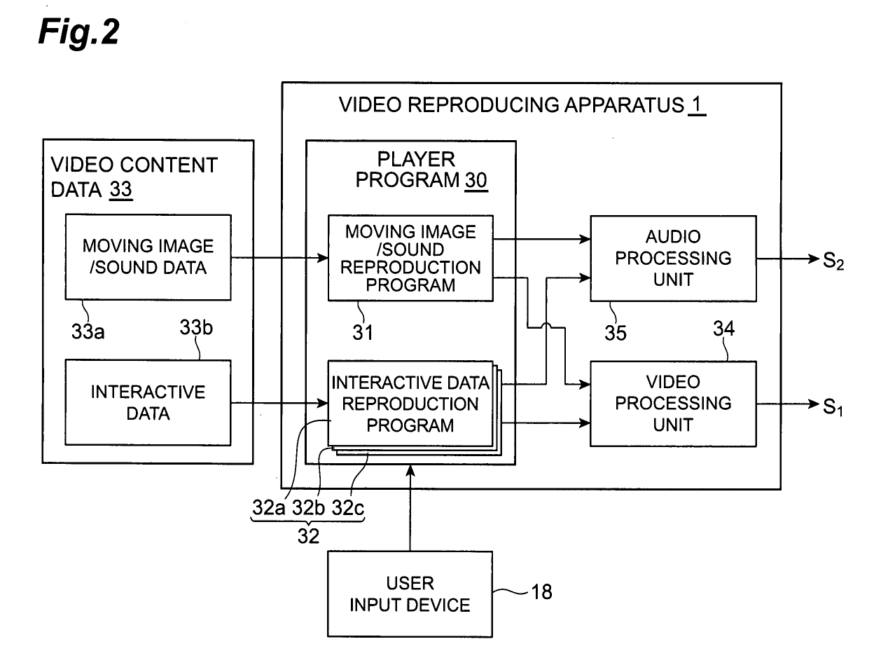

FIG. 2 is an exemplary block diagram showing the configuration of functions of the player program 30, the moving image/sound reproduction program 31, and an interactive data reproduction program 32 which are executed in the video reproducing apparatus 1 along with data to be inputted thereinto and outputted therefrom. The player program 30 is executed by the MPU 6. The player program 30 controls the moving image/sound reproduction program 31 and the interactive data reproduction program 32 shown in FIG. 2. Further, the player program 30 has a function of controlling initialization of the system, control of other programs, control of the system microcomputer 16 which controls the input processing by the user input device 18, system termination, and so on.

The moving image/sound reproduction program 31 is a program for reproducing moving image/sound data 33a contained in the video content data 33 and is executed by the data processor unit 10 under control of the MPU 6 which operates according to the player program 30.

When executing the moving image/sound reproduction program 31, the data processor unit 10 then receives input of the moving image/sound data 33a contained in the video content data 33, and outputs processed data to a video processing unit 34 (the above-described video decoder 11, video blending unit 13, and video output unit 14) and to an audio processing unit 35 (the above-described audio decoder 12 and audio output unit 15).

Then, the video output signal S1 is outputted from the video processing unit 34, and the audio output signal S2 is outputted from the audio processing unit 35.

The interactive data reproduction program 32 is a program for reproducing interactive data 33b contained in the video content data 33 and is executed by the data processor unit 10 under control of the MPU 6 which operates following the player program 30.

When executing the interactive data reproduction program 32, the data processor unit 10 then receives input of the interactive data 33b contained in the video content data 33, and outputs processed data to the video processing unit 34 and to the audio processing unit 35. Then, the video output signal S1 is outputted from the video processing unit 34, and the audio output signal S2 is outputted from the audio processing unit 35. The video processing unit 34 synchronizes a plurality of inputted data and outputs the video output signal S1. The audio processing unit 35 synchronizes a plurality of inputted data and outputs the audio output signal S2. Thus, when the video contents and interactive data are being simultaneously reproduced, the video processing unit 34 and the audio processing unit 35 output the video output signal S1 and the audio output signal S2, respectively, while synchronizing the inputted data.

Besides, the interactive data reproduction program 32 has a multi-task function capable of simultaneously executing a plurality of programs (three programs 32a, 32b, and 32c in FIG. 2) in the video reproducing apparatus 1, each of which holds a unique overlap rank at all times. The overlap rank is reflected in display of the interactive reproduced image (images of a menu display, an animation display, and so on displayed when the interactive data 33b is reproduced) on a later-described display screen 100. More specifically, when an interactive data reproduction program (for example, 32a) at a higher overlap rank and an interactive data reproduction program (for example, 32b) at an overlap rank lower than the higher overlap rank are being simultaneously executed, the interactive reproduced images are displayed according to the respective overlap ranks (in this case, the interactive reproduced image by the interactive data reproduction program 32a is displayed overlapped on the interactive reproduced image by the interactive data reproduction program 32b). The overlap ranks of the interactive data reproduction programs 32 sometimes dynamically changes, but the interactive data reproduction programs 32 are configured not to hold the same overlap rank.

The overlap ranks will be described in more detail as follows. In the case where a plurality of videos can be simultaneously displayed (for example, where the video reproducing apparatus 1 can read the video content data 33 recorded on an HD DVD: High Definition DVD, to reproduce the video contents), the plurality of video are displayed such that they are blended to overlap one on the other. In particular, in the case where a video in which, for example, a main video, a sub video, a sub picture, an external video (an interactive reproduced image) and a menu screen are blended in order from the lower side to the upper side is displayed on the display screen 100, they are displayed overlapped in the above order in a normal reproduction mode, but they can be displayed in a changed order in which the external video (the interactive reproduced image) is placed on the uppermost side (this order is freely changed by the way of generating the video content data 33). The overlap rank indicates that the interactive reproduced image is inserted to what number of rank among the videos to be reproduced, and the overlap rank is changed from the fourth to the fifth in the above case).

Under control of the MPU 6 which operates following the player program 30, the data processor unit 10 holds the overlap ranks in an array format (a data format in which data of the same type are consecutively arranged), stores them in a table or the like to manage the interactive data reproduction program 32. Note that the moving image/sound reproduction program 31 and the interactive data reproduction programs 32 are stored in a not-shown memory provided in the data processor unit 10.

The video content data 33 is composed of moving image/sound data 33a and interactive data 33b. The moving image/sound data 33a is data on moving image and sound to reproduce the video contents. The interactive data 33b is data containing menu data, animation data, sound effect data, content explanation data such as explanation of the video contents and so on, questions of quiz and so on which are reproduced in relation to (accompanying) the video contents, and corresponds to content-related data in the present invention.

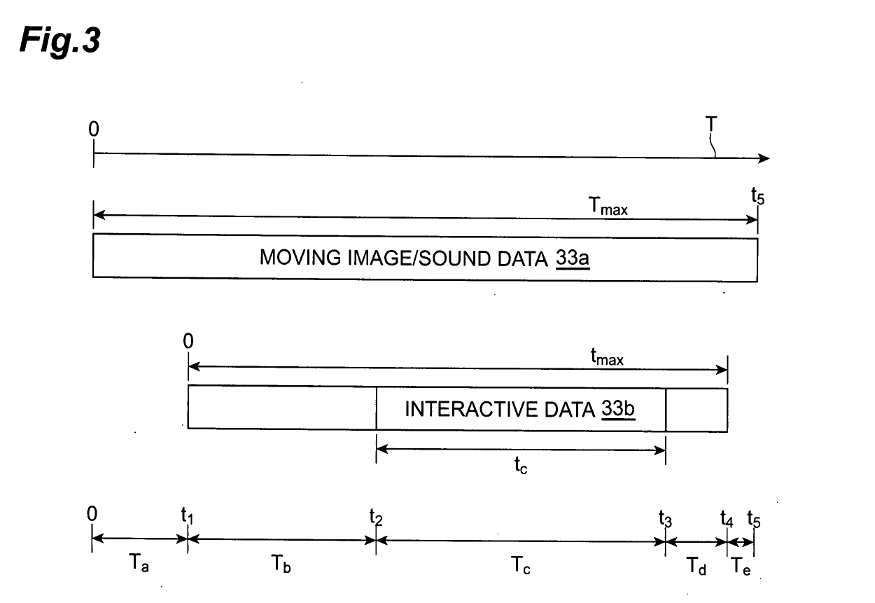

In the case of this embodiment, the moving image/sound data 33a and the interactive data 33b are used according to a reproduction schedule shown in FIG. 3. FIG. 3 is an exemplary diagram showing one example of the reproduction schedule when the video and sound are reproduced using the moving image/sound data 33a and the interactive data 33b.

The video contents corresponding to the video content data 33 are reproduced based on a video content reproducing time axis (hereinafter, referred to as a “reproducing time axis”) T. The reproducing time axis T is a time axis common to the moving image/sound data 33a and the interactive data 33b, and corresponds to an absolute time invariable in the video contents.

The lifetimes of both of the moving image/sound data 33a and the interactive data 33b during which they can be used for reproduction are determined on the reproducing time axis T, respectively, such that both the data can be reproduced only during the lifetimes. The lifetime of the moving image/sound data 33a is referred to as a moving image/sound data lifetime Tmax and the lifetime of the interactive data 33b is referred to as an interactive data lifetime tmax herein.

At a start position of the interactive data lifetime tmax, that is, at execution start time t1 of the interactive data reproduction program 32, execution of the interactive data reproduction program 32 is started. The reproduction of the interactive data 33b can be started from and stopped at an arbitrary time during the lifetime tmax. The reproduction start time of the interactive data 33b is t2 and the reproduction stop time is t3, and a period from the reproduction start time t2 to the reproduction stop time t3 is an interactive data reproduction period tc.

The data processor unit 10 saves the internal state set according to the execution status of the interactive data reproduction program 32 and the reproduction status of the interactive data 33b during the time when the interactive data reproduction program 32 is being executed. As the internal state, the following three states are set in this embodiment. The states include execution invalid states Ta and Te in which the time during which the moving image/sound data 33a is used for reproduction of the video contents (a content reproduction time) is without the lifetime tmax; stop states Tb and Td in which the content reproduction time is within the lifetime tmax and without the interactive data reproduction period tc; and a reproduction state Tc in which the content reproduction time is within the interactive data reproduction period tc.

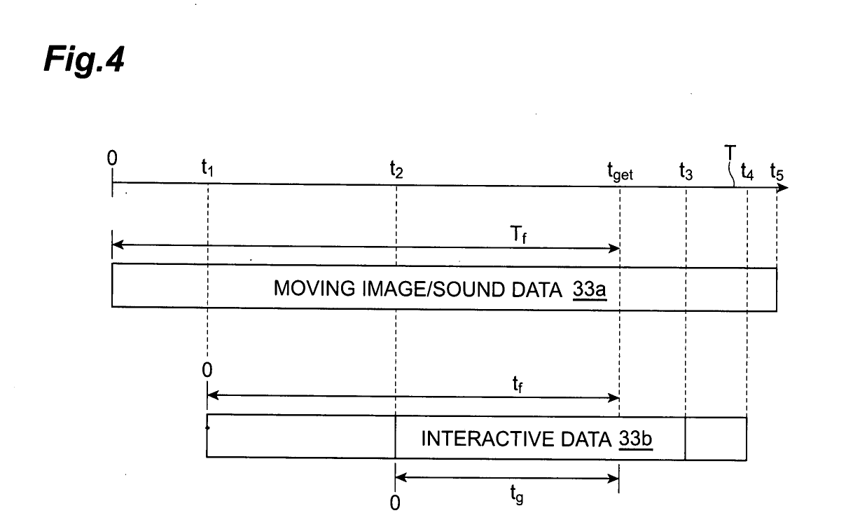

Subsequently, the definition of the reproduction times of the moving image/sound data 33a and the interactive data 33b will be described with reference to FIG. 4. It is assumed here that the MPU 6 has activated a later-described bookmark generation program and acquired (generated) the bookmark data 40 during the interactive data reproduction period tc by the operation input by the user as described later. The timing at which the bookmark data 40 has been acquired (bookmark acquisition timing) is regarded as tget. In this case, a video content reproduction elapsed time Tf is an elapsed time counted from an origin 0 of the video content reproducing time axis T to the bookmark acquisition timing tget.

Besides, an execution elapsed time t1 of the interactive data reproduction program 32 is an elapsed time counted from the execution start time t1 of the interactive data reproduction program 32 regarded as the origin 0 to the bookmark acquisition timing tget. An interactive data reproduction elapsed time tg is an elapsed time counted from the interactive data reproduction start time t2 regarded as the origin 0 to the bookmark acquisition timing tget.

### (Data Structure of Bookmark Data)

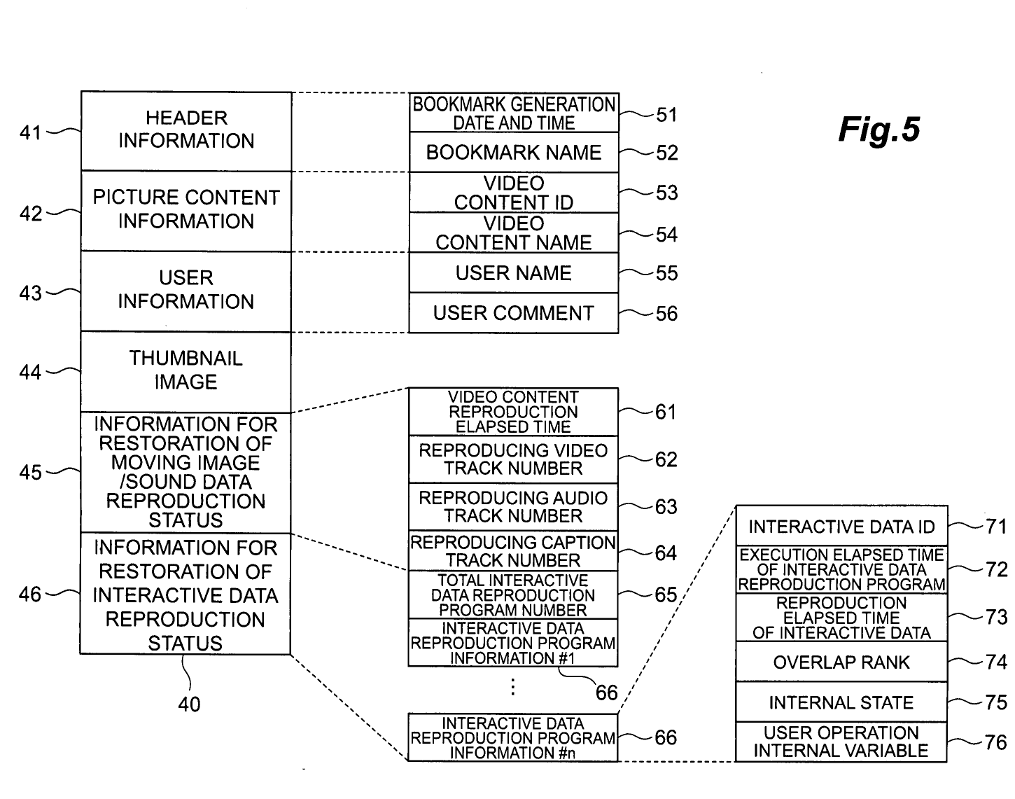

Next, the data structure of the bookmark data 40 which is a characteristic of the present invention will be described with reference to FIG. 5. FIG. 5 is an exemplary data layout diagram showing the data structure of the bookmark data. The bookmark data 40 has header information 41, video content information 42, user information 43, thumbnail image 44, first restoration information 45 and second restoration information 46.

The header information 41 is information for identifying the bookmark data 40 and contains generation date and time 51 and a bookmark name 52 of the bookmark data 40. The generation date and time 51 is information indicating date and time (year, month, day, time and so on) when the bookmark data 40 is generated, and the bookmark name 52 is composed of an array of arbitrary characters.

The video content information 42 is information for specifying the video contents which were being reproduced at the time of generation of the bookmark data 40 (referred also to as a bookmark generation time point, which corresponds to the above-described tget), and contains a video content ID 53 for identifying the video contents and a video content name 54. The video content ID 53 is a unique identification number given to the video contents by an author of the video contents, for which a unique value different from those of other video contents is set. The video content name 54 is composed of an array of arbitrary characters.

The user information 43 is information for determining the user who has performed operation input to generate the bookmark data 40 and managing the bookmark data 40 for each user, and contains a user name 55 and a user comment 56. As the user name 55, information indicating the name of a user composed of an array of arbitrary characters is stored. As the user comment 56, information indicating the name of a comment composed of an array of arbitrary characters is stored. The thumbnail image 44 is a saved image of the image displayed on the display screen 100 at the bookmark generation time point (an image including at least the video contents and in which both the video contents and the interactive reproduced image are combined and displayed in a composite manner if the interactive data 33b was being reproduced).

The first restoration information 45 is data for restoring the reproduction status at the bookmark generation time point (referred also to as information for restoration of the moving image/sound data reproduction status) when the video contents are reproduced using the above-described moving image/sound data 33a. In this embodiment, the first restoration information 45 contains a video content reproduction elapsed time 61, a reproducing video track number 62, a reproducing audio track number 63, and a reproducing caption track number 64. The video content reproduction elapsed time 61 is information indicating the reproduction time position of the moving image/sound data 33a at the bookmark generation time point, and data corresponding to the video content reproduction elapsed time Tf in FIG. 4 is stored as the information. As the reproducing video track number 62, the reproducing audio track number 63, and the reproducing caption track number 64, respective track numbers are stored which correspond to storage positions of the data which was being reproduced (which was during reproduction) at the bookmark generation time point of the track numbers constituting the storage medium on which the moving image/sound data 33a is recorded.

The second restoration information 46 is data for restoring the reproduction status at the bookmark generation time point (referred also to as information for restoration of the interactive data reproduction status) for the above-described interactive data 33b reproduced in relation with the video contents. In this embodiment, the second restoration information 46 contains a total interactive data reproduction program number 65 and interactive data reproduction program information 66.

As the total interactive data reproduction program number 65, the number of interactive data reproduction programs 32 which were being executed at the bookmark generation time point is stored together with the moving image/sound reproduction program 31. The interactive data reproduction program information 66 is information on the interactive data reproduction program 32 which was being reproduced, and a plurality of pieces of interactive data reproduction program information 66 are contained according to the number of the interactive data reproduction programs 32 which were being executed, each of which contains an interactive data ID 71, an execution elapsed time 72 of the interactive data reproduction program, a reproduction elapsed time 73 of the interactive data, an overlap rank 74, an internal state 75, and a user operation internal variable 76.

The interactive data ID 71 is information for uniquely determining each piece of interactive data 33b that is information given to the video contents by the author of the video contents. As the execution elapsed time 72, information is stored which corresponds to the execution elapsed time tf of the interactive data reproduction program 32 in FIG. 4. As the reproduction elapsed time 73, information is stored which corresponds to the interactive data reproduction elapsed time tg in FIG. 4. As the overlap rank 74, an integral value is stored which indicates the overlap rank of the interactive data reproduction program 32. As the internal state 75, any of the above-described execution invalid states Ta and Te, the stop states Tb and Td, and the reproduction state Tc in FIG. 3 is set.

The user operation internal variable 76 is information for restoring information in which a value dynamically varies by the operation input of the user (for example, information indicating the answer of a quiz, hereinafter referred to as “dynamically variable information”). The dynamically variable information cannot be restored only by the information on time such as the execution elapsed time tf because the value dynamically varies by the operation input of the user, and therefore the user operation internal variable 76 is set in the second restoration information 46 so that the dynamically variable information can be restored. As the user operation internal variable 76, a set of internal variables of the interactive data reproduction program 32 is stored in a later-described re-readable format. Note that although it is supposed that the bookmark data 40 are held in consecutive regions in this embodiment, each piece of the bookmark data 40 does not always need to be held in the consecutive regions.

### (Generation Processing of Bookmark Data)

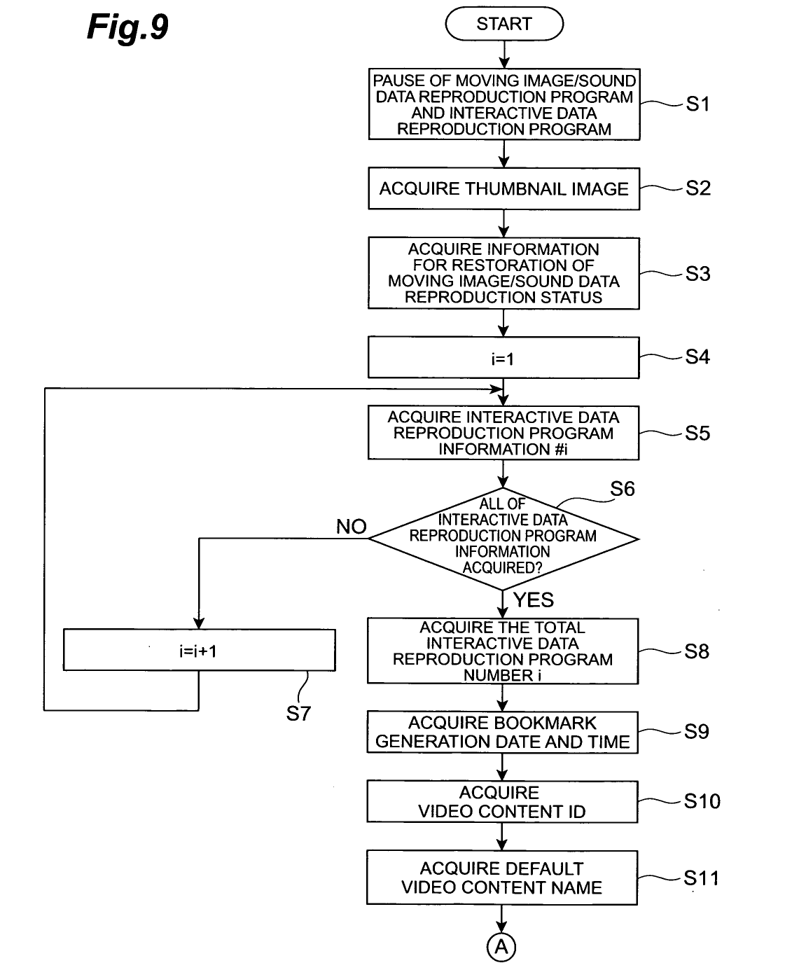

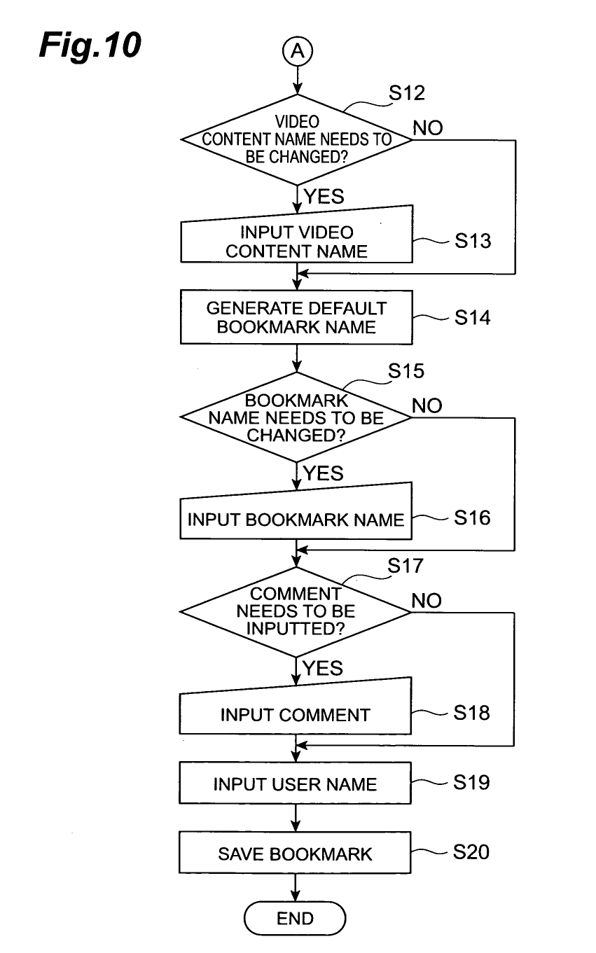

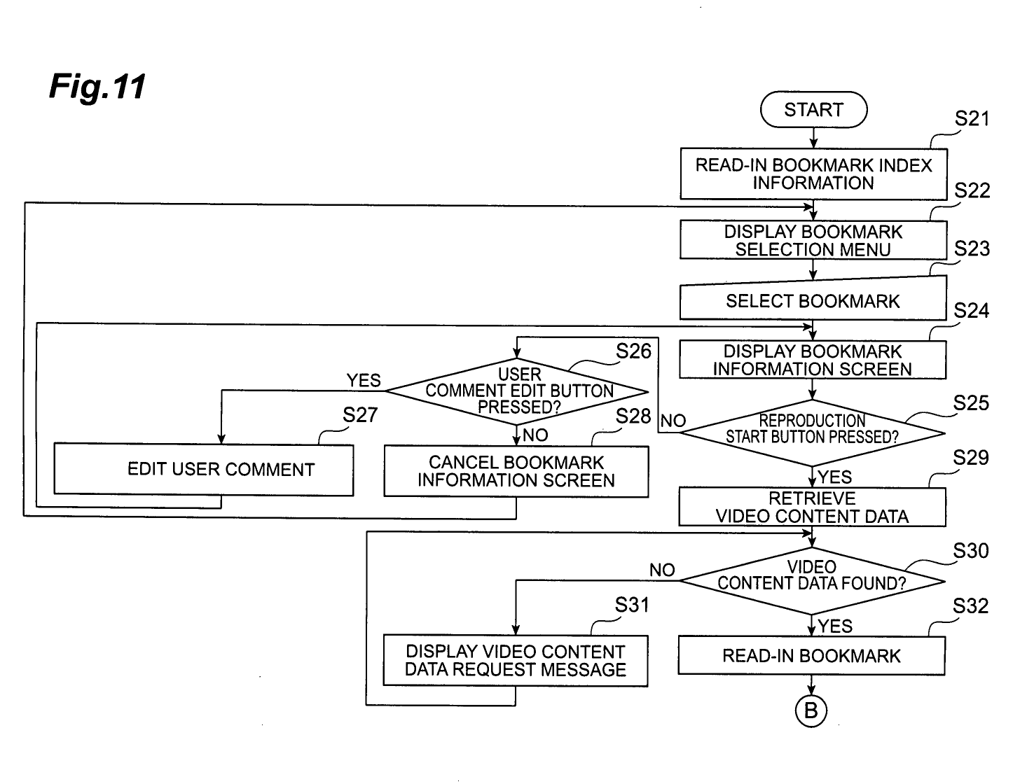

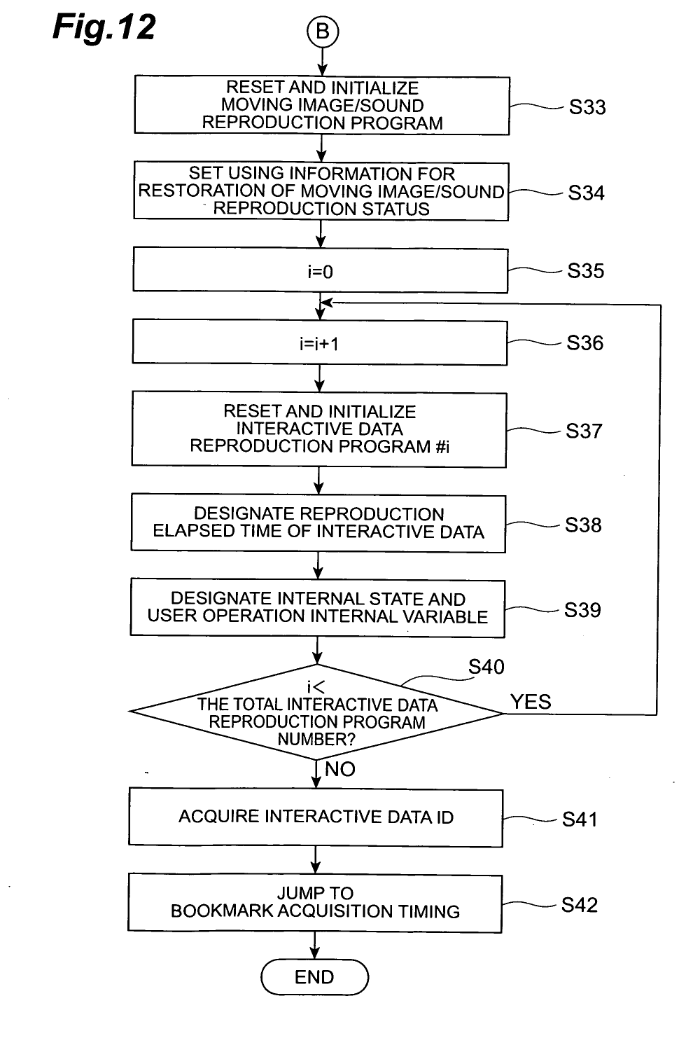

Next, a procedure of bookmark generation processing to generate the bookmark data 40 having the above-described configuration by the video reproducing apparatus 1 will be described with reference to FIG. 9 and FIG. 10. This bookmark generation processing is executed following the bookmark generation program by the MPU 6 having a function as a bookmark generation unit. Note that block is abbreviated as S in FIG. 9 and FIG. 10, and later-illustrated FIG. 11 and FIG. 12.

Upon start of the bookmark generation processing, the MPU 6 proceeds to block 1 and first instructs the data processor unit 10 to temporarily stop execution of the moving image/sound reproduction program 31 and the interactive data reproduction program 32 during reproduction of the video contents and the interactive data to thereby temporarily stop the reproduction of the video contents and the reproduction of the interactive data. Subsequently, the MPU 6 proceeds to block 2 and captures the image (an image including the video contents and in which both the video contents and the interactive reproduced image are combined and displayed in a composite manner if the interactive data 33b is being reproduced) displayed on the display screen 100 (a display screen of a television set or another image display device to which the video reproducing apparatus 1 is connected) at this point in time, and saves the image as a thumbnail image. In this case, the image to be saved, in a format to allow the image to be re-read when the player program 30 is activated (in a re-readable format), is saved in a predetermined area in a area where the bookmark data 40 in generation is temporarily stored (hereinafter referred to as a “bookmark area”) reserved in the memory 7.

When proceeding to block 3, the MPU 6 acquires the first restoration information (the video content reproduction elapsed time, the reproducing video track number, the reproducing audio track number, and the reproducing caption track number) at the temporarily stop time point of the moving image/sound reproduction program 31, from the predetermined storage area reserved in the memory 7 or the like, and saves them in a predetermined area in the bookmark area.

Subsequently, the MPU 6 proceeds to block 4 and sets “1” in a program counter i, and then proceeds to block 5 and acquires the second restoration information (the interactive data ID, the execution elapsed time of the interactive data reproduction program, the interactive data reproduction elapsed time, the overlap rank, the internal state, and the user operation internal variable) at the temporarily stop time point of the interactive data reproduction program 32 corresponding to the program counter i, from the predetermined storage area reserved in the memory 7 or the like, and saves them in a predetermined area in the bookmark area. Then, the MPU 6 proceeds to block 6 and determines whether or not it has acquired all of the second restoration information by the interactive data reproduction program 32. The MPU 6 proceeds to block 8 when determining that it has acquired the second restoration information, and otherwise proceeds to block 7. When proceeding to block 7, the MPU 6 adds “1” to the program counter i and changes the interactive data reproduction program 32 to be determined, and then returns to block 5 to repeat the processing in block 5.

When proceeding to block 8, the MPU 6 acquires the numerical value of the program counter i as the total interactive data reproduction program number and then saves the value in a predetermined region in the bookmark area. In subsequent block 9, the MPU 6 acquires a system date and a system time as the generation date and time (year, month, day, time and so on) of the bookmark data 40 and saves them in a predetermined area in the bookmark area. Further, proceeding to block 10, the MPU 6 acquires the video content ID of the video contents which were being reproduced from the moving image/sound data 33a and saves the acquired video content ID in a predetermined area in the bookmark area. In subsequent block 11, the MPU 6 sets a default video content name as the video content name, and saves the name in a predetermined area in the bookmark area.

In block 12, the MPU 6 determines whether or not the user wants to change the video content name according to the operation input signal from the user input device 18. When it is determined that the user wants to change the name here, the MPU 6 proceeds to block 13 and shifts to a not-shown video content name entry screen to prompt the user to input a video content name, and then overwrites the character string inputted by the user in a predetermined area in the bookmark area, and then proceeds to block 14. Otherwise, the MPU 6 proceeds to block 14 without executing block 13.

Further, when proceeding to block 14, the MPU 6 performs default bookmark name generation processing, for example, by giving serial numbers after an arbitrary character string, such as “bookmark 1,” “bookmark 2,” and “bookmark 3” and saves the generated default bookmark names in a predetermined area in the bookmark area. In subsequent block 15, the MPU 6 determines whether or not the user wants to change the bookmark name according to the operation input signal from the user input device 18. When it is determined that the user wants to change the name, the MPU 6 proceeds to block 16 and shifts to a not-shown bookmark name entry screen to prompt the user to input a bookmark name. The MPU 6 then overwrites the inputted character string in a predetermined area in the bookmark area, and then proceeds to block 17. Otherwise, the MPU 6 proceeds to block 17 without executing block 16.

In subsequent block 17, the MPU 6 determines whether or not the user wants to change the comment according to the operation input signal from the user input device 18. When it is determined that the user wants to change the comment, the MPU 6 proceeds to block 18 and shifts to a not-shown comment entry screen to prompt the user to input a comment. The MPU 6 then saves a character string as the inputted comment in a predetermined area in the bookmark area, and then proceeds to block 19. Otherwise, the MPU 6 proceeds to block 19 without executing block 18.

When proceeding to block 19, the MPU 6 saves, in a predetermined area in the bookmark area, the character string inputted by the user or the user name selected from a user list previously set and registered by the user using the player program 30.

In block 20, the MPU 6 performs saving processing to write the data in the bookmark area generated in the processing in block 2 to block 19, into a readable/writable device (for example, the flash memory 3 or the hard disk drive 2) as a bookmark file in a re-readable format. Thus, the bookmark data 40 is generated. The bookmark data 40 thus generated will be stored in the flash memory 3 or the hard disk drive 2 as a storage medium.

### (Display of Bookmark Data)

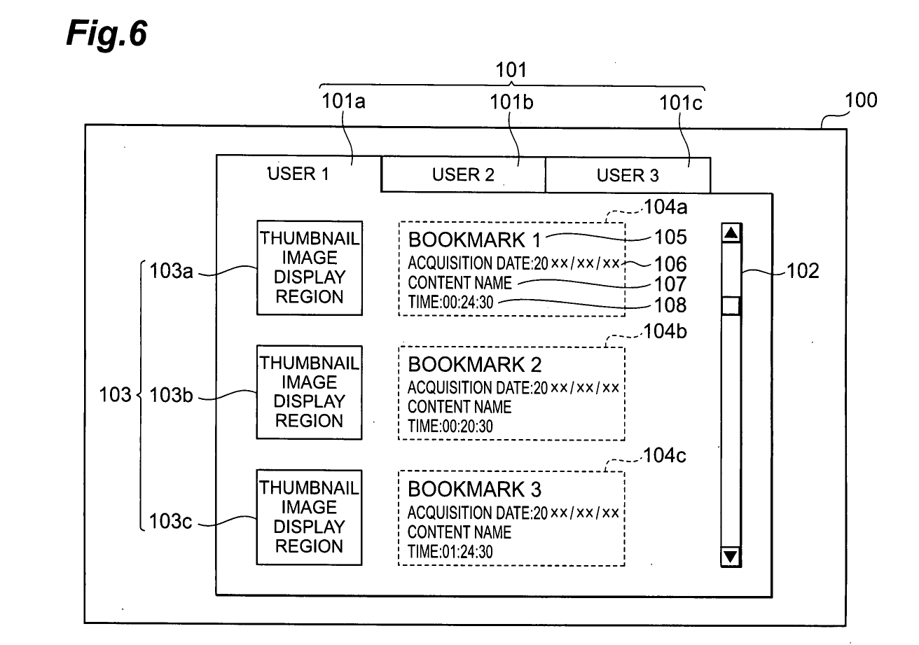

On the other hand, the video reproducing apparatus 1 sorts the bookmark data 40 generated in the above-described manner for each user and edits and displays the data in a predetermined layout so that the user can select desired bookmark data 40. Subsequently, a procedure of sorting the bookmark data 40 for each user and editing and displaying the data to prompt the user to select the data will be described with reference to FIG. 6.

FIG. 6 is an exemplary diagram showing one example of a bookmark selection menu 101 in a thumbnail format to be displayed. As shown in FIG. 6, bookmark selection menus 101 (101a, 101b, and 101c) are displayed on the display screen 100. The bookmark selection menus 101 (101a, 101b, and 101c) are made by sorting the generated bookmark data 40 for each user using, as a key, the data of the user name 55 constituting the user information 43, and aligning the bookmark data 40 using, as a key, the data of the video content ID 53 constituting the video content information 42 and displaying the data in a predetermined layout. The user can select desired bookmark data 40 while viewing the displayed data. Note that the bookmark selection menus 101 shown in FIG. 6 are displayed by the MPU 6 operating as an alignment and display control unit and a sort and display control unit in the present invention.

Each bookmark selection menu 101 has a slide bar 102, thumbnail image display regions 103, and bookmark-related information display regions 104a, 104b, and 104c. The slide bar 102 is displayed when all the bookmark data 40 cannot be displayed within the bookmark selection menu 101, so that the remaining bookmark data 40 is displayed by sequentially sliding the displayed bookmark data 40. The thumbnail image display region 103 is a region for displaying the thumbnail image using the data of the thumbnail image 44 contained in the bookmark data 40, and three thumbnail images 103a, 103b, and 103c are shown in FIG. 6.

Each of the bookmark-related information display regions 104a, 104b, and 104c, which are displayed corresponding to the respective thumbnail image display regions 103, has a bookmark name display region 105, a bookmark generation date and time display region 106, a video content name display region 107, and a reproduction elapsed time display region 108. In the bookmark name display region 105, data of the bookmark name 52 in the bookmark data 40 is displayed. In the bookmark generation date and time display region 106, data of the bookmark generation date and time 51 is displayed. In the video content name display region 107, data of the video content name 54 is displayed. Further, in the reproduction elapsed time display region 108, data of the video content reproduction elapsed time 61 is displayed. Note that, it is conceivable to align the bookmark name, the video content name, the bookmark generation time, and the user comment, other than information displayed in the illustrated regions to form the bookmark so as to display another bookmark selection menu.

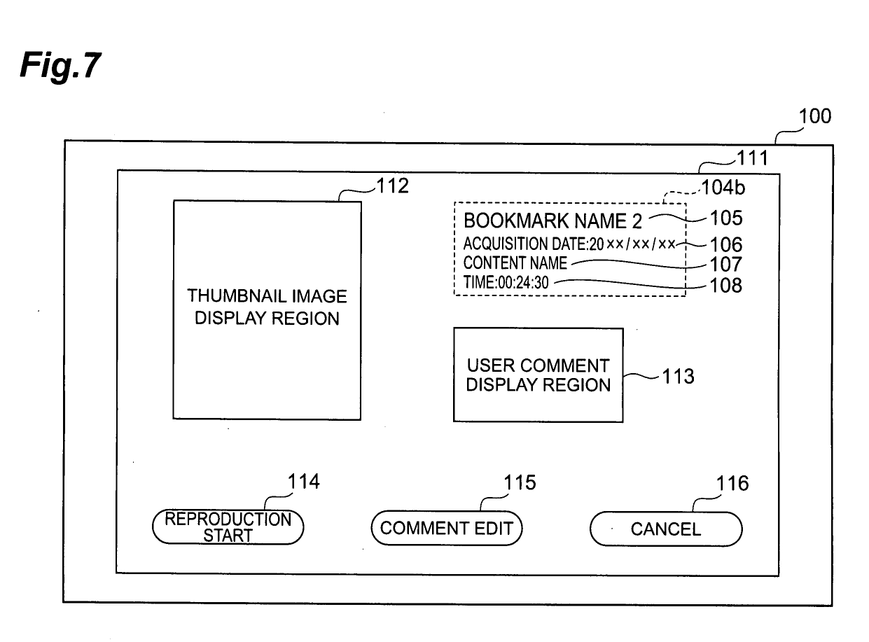

The user can retrieve and select desired bookmark data 40 referring to the above-described bookmark selection menu 101. In this case, the user first performs input operation (for example, remote control) of the user input device 18 to select desired bookmark data 40, for example, by placing the cursor thereon referring to the thumbnail image displayed in the thumbnail image display region 103. Then, screen shift is performed in which the image displayed on the display screen 100 is changed from the bookmark selection menu 101 to a bookmark information screen 111 shown in FIG. 7.

FIG. 7 is an exemplary diagram showing one example of the bookmark information screen 111. The bookmark information screen 111 has a thumbnail image display region 112, the bookmark-related information display region 104b, a user comment display region 113, a reproduction start button 114, a comment edit button 115, and a cancel button 116. Data of the thumbnail image 44 in the bookmark data 40 selected by the user is displayed in the thumbnail image display region 112. Bookmark-related information (information similar to the bookmark name display region 105, the bookmark date and time display region 106, the video content name display region 107, and the reproduction elapsed time display region 108) in the bookmark data 40 selected by the user is displayed in the bookmark-related information display region 104b.

Data of the user comment 56 in the selected bookmark data 40 is displayed in the user comment display region 113. The reproduction start button 114 is a button for instructing start of reproduction from the bookmark position corresponding to the bookmark data 40. The comment edit button 115 is a button for instructing start editing the user comment. The cancel button 116 is a button for instructing screen shift from the bookmark information screen 111 to the bookmark selection menu 101.

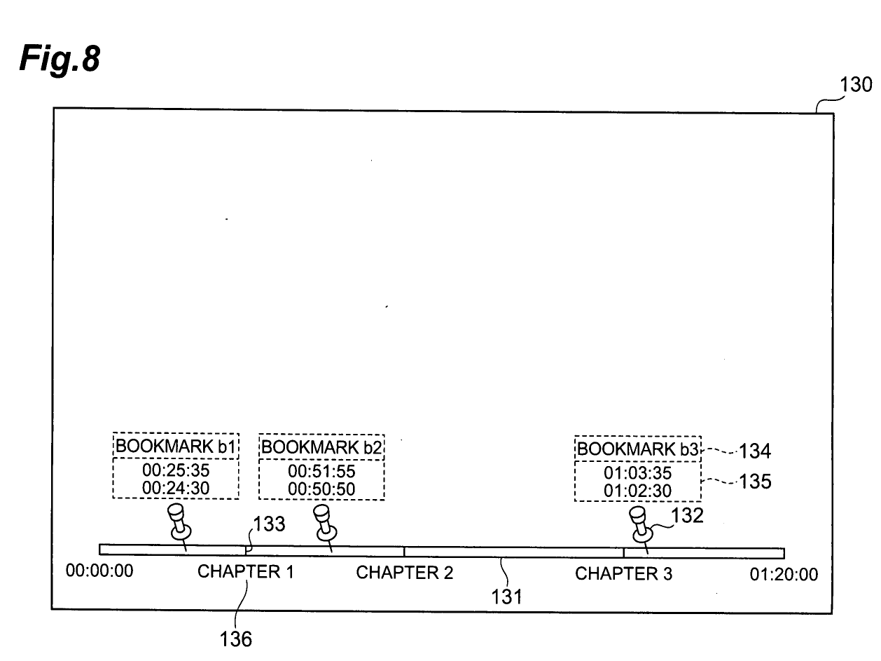

In addition, the video reproducing apparatus 1 is configured such that desired bookmark data 40 can be selected also from a bookmark selection menu 130 in a progress bar format as shown in FIG. 8 other than the bookmark selection menu in the thumbnail format shown in FIG. 6. FIG. 8 is an exemplary diagram showing one example of the bookmark selection menu 130 in a progress bar type. In FIG. 8, a progress bar 131 is displayed which shows the progress of a reproduction time when reproducing the video contents. Further, bookmark symbols 132 corresponding to the bookmark data 40 are displayed such that they are arranged in time series depending on bookmark generation time and overlapped on the progress bar 131. Note that the bookmark selection menu in a progress bar type shown in FIG. 8 is displayed by the MPU 6 operating as a progress bar display control unit and a time-series display control unit.

The bookmark symbols 132, chapter symbols 133, bookmark name display regions 134, reproduction elapsed time display regions 135, and chapter name display regions 136 are displayed in the bookmark selection menu 130.

The bookmark symbol 132 indicates that the bookmark data 40 is generated at the bookmark acquisition timing tget. The bookmark symbol 132 is disposed at a location corresponding to the bookmark acquisition timing tget on the progress bar 131 using the video content reproduction elapsed time 61 in the bookmark data 40. The chapter symbol 133 indicates a setting time of the chapter set in the video contents. In the bookmark name display region 134, data of the bookmark name 52 in the bookmark data 40 corresponding to the bookmark symbol 132 is displayed. In the reproduction elapsed time display region 135, data of the video content reproduction elapsed time 61 and the interactive data reproduction elapsed time 73 in the bookmark data 40 are displayed in two columns (the former at the upper column and the latter at the lower column). In the chapter name display region 136, the chapter name set by the author of the video contents or the chapter name appropriately set by the player program 30 is displayed.

When the bookmark selection menu 130 is displayed, the user can select desired bookmark data 40 from among a plurality of bookmark data 40 (three bookmarks b1, b2, and b3 in FIG. 8) referring to the bookmark symbols 132 arranged on the progress bar 131. Upon selection of the bookmark data 40, screen shift to the bookmark information screen 111 shown in FIG. 7 is performed.

### (From Selection of Bookmark Data to Reproduction of Video Contents and so on)

When the user selects desired bookmark data 40 referring to the bookmark selection menu 101 or 130 in FIG. 6 or FIG. 8 and inputs an instruction on the bookmark information screen 111 in FIG. 7 using the reproduction start button 114, reproduction of the video contents and the interactive data in a composite manner is started according to the selected bookmark data 40.

Hence, a procedure from the display and selection of the bookmark data 40 to the start of reproduction of the video contents and the interactive data in a composite manner will be subsequently described with reference to FIG. 11 and FIG. 12. FIG. 11 and FIG. 12 are flowcharts showing a procedure of processing of the display and selection of the bookmark data 40 to the start of reproduction of the video contents and the interactive data in a composite manner (hereinafter referred to as “reproduction start preparation processing”).

Upon start of the reproduction start preparation processing, the MPU 6 proceeds to block 21 and operates as a read-in unit to access the flash memory 3 or the hard disk drive 2 in which the bookmark files is saved and read in all of the saved bookmark data 40. Then, the MPU 6 proceeds to block 22 and displays the bookmark selection menu 101 or the bookmark selection menu 130 on the display screen 100 using specific information from the bookmark data 40 read-in in block 21. Subsequently, the MPU 6 proceeds to block 23 and prompts the user to select any of the arbitrary bookmark data 40 displayed in the bookmark selection menu 101 or the bookmark selection menu 130 (waits until it is selected), and proceeds to block 24 after selection of the bookmark data 40 and edits the selected bookmark data 40 and displays the bookmark information screen 111. Subsequently, the MPU 6 proceeds to block 25 and determines whether or not the reproduction start button 114 has been pressed by the user. The MPU 6 proceeds to block 29 when determining that the button has been pressed, and otherwise proceeds to block 26.

When proceeding to block 26, the MPU 6 then determines whether or not the comment edit button 115 has been pressed by the user. The MPU 6 proceeds to block 27 when determining that the button has been pressed, and executes block 27 and then returns to block 24. Otherwise, the MPU 6 executes block 28 and then returns to block 22.

When proceeding to block 27, the MPU 6 overwrites the character string inputted by the user over the user comment 56 in the bookmark data 40 to perform edit processing of the user comment. In block 28, the MPU 6 performs processing caused by the user pressing the cancel button 116 (cancel of display of the bookmark information screen 111).

On the other hand, when proceeding to block 29, the MPU 6 retrieves the video content data 33 of the video contents to be reproduced (hereinafter referred to as “reproduction object content data”) from the optical disk 203 or the hard disk drive 2 according to the video content ID 53 in the bookmark data 40 selected in block 23.

Next, when proceeding to block 30, the MPU 6 determines whether or not reproduction object content data has been detected (found) in block 29. If the data has been found here, the MPU 6 proceeds to block 32. Otherwise, the MPU 6 executes block 31 and then returns to block 30. In block 31, the MPU 6 acquires the video content name 54 in the bookmark data 40 selected in block 23, and then causes the display panel 17 to display a message (video content data request message) that requests the user to set the recording medium (optical disk) 203 saving the reproduction object content data into the disk drive 4.

When proceeding to block 32, the MPU 6 reads-in the bookmark data 40 selected in block 23 and stores all the data into the memory 7 in order to read out the data when the player program 30 is activated.

Next, the MPU 6 proceeds to block 33 and resets and initializes the moving image/sound reproduction program 31. In subsequent block 34, the MPU 6 designates a track number and so on in which the reproduction object content data is stored using the first restoration information 45 of the data stored in the memory 7 in block 32, and executes the moving image/sound reproduction program 31. Thus, the MPU 6 sets the first restoration conditions for restoring the reproduction status of the video contents at the bookmark generation time point. As described above, the first restoration conditions are set to restore the reproduction status of the video contents at the bookmark generation time point.

Further, in subsequent block 35, the MPU 6 sets “0” in the program counter i. In subsequent block 36, the MPU 6 adds “1” to the program counter i. In subsequent block 37, the MPU 6 performs reset and initialization of the interactive data reproduction program 32 corresponding to the program counter i. In block 38, the MPU 6 designates the reproduction elapsed time of the interactive data reproduction program 32 corresponding to the program counter i using the second restoration information 46. In subsequent block 39, the MPU 6 designates the internal state of the interactive data reproduction program 32 corresponding to the program counter i and the user operation internal variable, and then executes the interactive data reproduction program 32. Thus, the MPU 6 sets the second restoration conditions for restoring the reproduction status at the bookmark generation time point of the interactive data. The second restoration conditions are set to restore the reproduction status of the interactive data at the bookmark generation time point.

The MPU 6 then proceeds to block 40 and determines whether or not the program counter i is smaller than the data of the total interactive data reproduction program number 65. When determining that it is smaller, the MPU 6 returns to block 36, and otherwise proceeds to block 41. In this manner, the MPU 6 repeatedly executes the above-described block 36 to block 39 until the program counter i matches with the total interactive data reproduction program number 65.

In block 41, the MPU 6 acquires the interactive data ID 71 according to the overlap rank 74 and saves it in order to read it out when the player program 30 is activated. Thus, the MPU 6 allows the reproduction status to be restored according to the overlap rank 74 of the interactive data 33b. Further, in block 42, the MPU 6 instructs the data processor unit 10 to jump to the bookmark acquisition timing tget according to the video content reproduction elapsed time 61 and start reproduction of the video contents and the interactive data at the bookmark acquisition time point.

Then, the data processor unit 10 refers to the first restoration conditions and the second restoration conditions set in blocks 34 and 38, and executes the moving image/sound reproduction program 31 and the interactive data reproduction program 32 according to the conditions. In this case, the data processor unit 10 reproduces the video contents from the position corresponding to the first restoration conditions. The data processor unit 10 further reproduces the interactive data 33b from the position corresponding to the second restoration conditions and also reproduces the internal state and the user operation internal variable in correspondence with the second restoration conditions. The data processor unit 10 further displays the interactive reproduced images according to the overlap ranks 74 when executing a plurality of interactive data reproduction programs 32.

The reproduction start preparation processing is performed in the above-described manner, whereby the composite reproduction status of the video contents and the interactive data at the bookmark generation time point will be recreated (restored). For example, when the video contents and the image indicating explanation of the video contents as the interactive reproduced image therewith were being displayed at the bookmark generation time point, the video contents and the image indicating the explanation are reproduced in a composite manner.

As described above, the bookmark data 40 in the present invention has the second restoration information for restoring the reproduction status when the interactive data was reproduced as well as the first restoration information for restoring the reproduction status when the video contents were reproduced. Therefore, the video reproducing apparatus 1 can reproduce the video contents and the interactive data from an arbitrary reproduction time according to the first restoration information and the second restoration information.

In addition, the bookmark data 40 is saved in a re-readable format using the data acquired at the point in time when the video contents and the interactive data 33b were being reproduced. Accordingly, through use of the bookmark data 40, the video reproducing apparatus 1 can restore the composite reproduction status of the video contents and the interactive data. In particular, the thumbnail image 44 is an image in which the video contents and the interactive reproduced image are combined and both are displayed in a composite manner. Consequently, the image display is performed using the thumbnail image 44 to make restoration of the reproduction status visually apparent.

Further, in the video reproducing apparatus 1, the bookmark data 40 additionally has the header information 41, the video content information 42, the user information 43, and the thumbnail image 44, so that the bookmark data 40 are displayed as a library to facilitate retrieval and selection of desired bookmark data 40.

Further, in the video reproducing apparatus 1, the bookmark data 40 can be sorted for each user using the user information 43 for edit and display, so that the user can easily retrieve the bookmark data 40. Furthermore, a plurality of bookmark data 40 can also be aligned for edit and display, so that the user can easily select the bookmark data 40. Moreover, the bookmark selection menu 130 in a progress bar format is also displayed in which the progress bar 131 is displayed and the bookmark symbols 132, the chapter symbols 133 and so on are displayed on the progress bar 131. As a result, it is easy for the user to visually retrieve and select desired bookmark data 40.

As has been described in detail, according to the present invention, a video reproducing apparatus with a function of generating bookmark data to enable restoration of a composite reproduction status of content reproduction processing and processing other than the content reproduction processing, a data structure of the bookmark data, a storage medium storing the bookmark data, and a method of generating the bookmark data.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video reproducing apparatus, comprising:
a video reproducing device reproducing video contents; and
a bookmark generation unit for generating bookmark data having first restoration information for restoring a reproduction status when said video reproducing device reproduced the video contents using moving image/sound data contained in video content data for reproducing the video contents, and second restoration information for restoring a reproduction status when said video reproducing device reproduced content-related data reproduced in relation to the video contents.

2. The video reproducing apparatus according to claim 1, further comprising:
a bookmark read-in unit for reading-in the bookmark data generated by said bookmark generation unit,
wherein said video reproducing device reproduces the video contents and the content-related data according to the first restoration information and the second restoration information contained in the bookmark data read-in by said bookmark read-in unit, so that the reproduction status of the video contents and the reproduction status of the content-related data at an arbitrary reproduction time are restored.

3. The video reproducing apparatus according to claim 1,
wherein said bookmark generation unit generates the bookmark data such that the bookmark data contains video content information for specifying the video contents as well as the first restoration information and the second restoration information, said video reproducing apparatus further comprising:
an alignment and display control unit for aligning and displaying the bookmark data according to the video content information contained in the bookmark data generated by said bookmark generation unit.

4. The video reproducing apparatus according to claim 2,
wherein said bookmark generation unit generates the bookmark data such that the bookmark data contains video content information for specifying the video contents as well as the first restoration information and the second restoration information, said video reproducing apparatus further comprising:
an alignment and display control unit for aligning and displaying the bookmark data according to the video content information contained in the bookmark data generated by said bookmark generation unit.

5. The video reproducing apparatus according to claim 1,
wherein said bookmark generation unit generates the bookmark data such that the bookmark data contains user information for managing the bookmark data for each user as well as the first restoration information and the second restoration information, said video reproducing apparatus further comprising:
a sort and display control unit for sorting and displaying the bookmark data according to the user information contained in the bookmark data generated by said bookmark generation unit.

6. The video reproducing apparatus according to claim 2,
wherein said bookmark generation unit generates the bookmark data such that the bookmark data contains user information for managing the bookmark data for each user as well as the first restoration information and the second restoration information, said video reproducing apparatus further comprising:
a sort and display control unit for sorting and displaying the bookmark data according to the user information contained in the bookmark data generated by said bookmark generation unit.

7. The video reproducing apparatus according to claim 3,
wherein said bookmark generation unit generates the bookmark data such that the bookmark data contains user information for managing the bookmark data for each user as well as the first restoration information and the second restoration information, said video reproducing apparatus further comprising:
a sort and display control unit for sorting and displaying the bookmark data according to the user information contained in the bookmark data generated by said bookmark generation unit.

8. The video reproducing apparatus according to claim 1, further comprising:
a progress bar display control unit for displaying a progress bar indicating a reproduction time progress when said video reproducing device reproduces the video contents; and
a time-series display control unit for displaying the bookmark data generated by said bookmark generation unit in time series on the progress bar displayed by said progress bar display control unit.

9. The video reproducing apparatus according to claim 2, further comprising:
a progress bar display control unit for displaying a progress bar indicating a reproduction time progress when said video reproducing device reproduces the video contents; and
a time-series display control unit for displaying the bookmark data generated by said bookmark generation unit in time series on the progress bar displayed by said progress bar display control unit.

10. The video reproducing apparatus according to claim 3, further comprising:
a progress bar display control unit for displaying a progress bar indicating a reproduction time progress when said video reproducing device reproduces the video contents; and
a time-series display control unit for displaying the bookmark data generated by said bookmark generation unit in time series on the progress bar displayed by said progress bar display control unit.

11. The video reproducing apparatus according to claim 4, further comprising:
a progress bar display control unit for displaying a progress bar indicating a reproduction time progress when said video reproducing device reproduces the video contents; and
a time-series display control unit for displaying the bookmark data generated by said bookmark generation unit in time series on the progress bar displayed by said progress bar display control unit.

12. The video reproducing apparatus according to claim 1, wherein said bookmark generation unit generates the bookmark data such that at least one of an interactive data ID, an execution elapsed time, a reproduction elapsed time, an overlap rank, an internal state, and a user operation internal variable is contained in the second restoration information.

13. The video reproducing apparatus according to claim 2, wherein said bookmark generation unit generates the bookmark data such that at least one of an interactive data ID, an execution elapsed time, a reproduction elapsed time, an overlap rank, an internal state, and a user operation internal variable is contained in the second restoration information.

14. The video reproducing apparatus according to claim 3, wherein said bookmark generation unit generates the bookmark data such that at least one of an interactive data ID, an execution elapsed time, a reproduction elapsed time, an overlap rank, an internal state, and a user operation internal variable is contained in the second restoration information.

15. The video reproducing apparatus according to claim 4, wherein said bookmark generation unit generates the bookmark data such that at least one of an interactive data ID, an execution elapsed time, a reproduction elapsed time, an overlap rank, an internal state, and a user operation internal variable is contained in the second restoration information.

16. A data structure of bookmark data generated in a video reproducing apparatus with a video reproducing device, for restoring a reproduction status at an arbitrary reproduction time when the video reproducing device reproduced video contents, said structure comprising:
first restoration information for restoring a reproduction status when the video reproducing device reproduced the video contents using moving image/sound data contained in video content data for reproducing the video contents, and second restoration information for restoring a reproduction status when the video reproducing device reproduced content-related data reproduced in relation to the video contents.

17. The data structure according to claim 16, further comprising:
video content information for specifying the video contents.

18. The data structure according to claim 16, further comprising:
user information for managing the bookmark data for each user.

19. A storage medium storing bookmark data generated in a video reproducing apparatus with a video reproducing device, for restoring a reproduction status at an arbitrary reproduction time when the video reproducing device reproduced video contents,
wherein the bookmark data has first restoration information for restoring a reproduction status when the video reproducing device reproduced the video contents using moving image/sound data contained in video content data for reproducing the video contents, and second restoration information for restoring a reproduction status when the video reproducing device reproduced content-related data reproduced in relation to the video contents.

20. A method of generating bookmark data for restoring a reproduction status at an arbitrary reproduction time when a video reproducing device reproduced video contents, comprising:
acquiring first restoration information for restoring a reproduction status when the video reproducing device is reproducing the video contents using moving image/sound data contained in video content data for reproducing the video contents, and acquiring second restoration information for restoring a reproduction status when the video reproducing device is reproducing content-related data reproduced in relation to the video contents; and
generating the bookmark data by performing saving processing of writing the acquired first restoration information and second restoration information into a storage medium in a re-readable format.
